(19) United States
(12) Patent Application Publication
(10) Pub. No.: US 2025/0092632 A1
(43) Pub. Date: Mar. 20, 2025

(54) CORNER SEGMENT

(71) Applicant: Caterpillar Inc., Peoria, IL (US)

(72) Inventors: Eric T. SINN, Tremont, IL (US); Douglas C. SERRURIER, Morton, IL (US); Jerome SENDON, Peoria, IL (US)

(73) Assignee: Caterpillar Inc., Peoria, IL (US)

(21) Appl. No.: 18/470,692

(22) Filed: Sep. 20, 2023

(51) Int. Cl. E02F 3/36; E02F 9/28

(52) U.S. Cl. CPC E02F 3/36; E02F 9/2883

(57) ABSTRACT

A corner segment configured to be mounted to a work implement using a plurality of bolts may include a head portion, a base portion, integrally formed with the head portion, and having at least one base bolt hole extending from a lower surface of the base portion to an upper surface of the base portion, the at least one base bolt hole being configured to receive a bolt to secure the corner segment to the work implement, and a side portion, integrally formed with the head portion and the base portion, and having at least one side bolt hole extending from an outer surface of the side portion to an inner surface of the side portion, the at least one side bolt hole being configured to receive a bolt to secure the corner segment to the work implement.

### TECHNICAL FIELD

The present disclosure relates generally to a corner segment mountable on a work implement, such as a bucket of a wheel loader, and, more particularly, to a corner segment having a plurality of bolt-holes provided on more than one surface of the corner segment.

### BACKGROUND

A work implement, such as a bucket, is mounted to a machine and used to dig into and to move materials, such as sand, gravel, stone, soil, or debris. The bucket may have a ground engaging tool (GET) mounted to an edge of the bucket. The GET engages with the materials to protect the edge of the bucket from wear and, therefore, prolongs the life of the bucket. GETs can be welded to work implements, however, welding of GETs can be dangerous, as it requires use of an open flame and high heat. Further, machines used in mining operations may be located underground, at a mining site, and replacing a GET on such a machine requires either welding at the mining site, underground, exacerbating the danger of using the open flame and high heat, or retrieving the machine from the mining site, which prolongs the downtime of the machine.

GETs can instead be secured to work implements using hardware, such as bolts, referred to as bolt-on GETs. Bolt-on GETs may be easier to replace in the field (for example, underground at a mining site), and replacement of bolt-on GETs avoids the dangers associated with welded GETs. Bolt-on GETs are, however, limited in relative size, due to the stresses of loads on the hardware used to secure the bolt-on GETs to the work implement. In other words, dimensions and thicknesses of portions of GETs may be limited due to stresses acting on the hardware, the stresses being caused by loads when the work implement moves materials. Specifically, loads acting on a front of a bolt-on GET having a relatively increased thickness may result in bolt shear of the hardware securing the GET to a work implement. Bolt-on GETs are also limited in relative size by a thickness of a neighboring GET, for example, a thickness of a corner GET is limited to that of an adjacent front GET, so as not to create a step at which stress and/or debris can concentrate. These limits on size result in a relatively short wear life of a GET.

To mitigate structural failure of a lip of a bucket and to reduce downtime for service and repair of a bucket including GETs, such as half arrows, European Patent Publication No.

EP4015710A1 (the '710 publication) provides for a corner half arrow for a lip of a bucket, the corner half arrow having a front wear portion, a side wear portion, a back portion for attachment to the lip of the bucket, and an inner side portion for facing an adjacent intermediate half arrow. The inner side portion extends along a first longitudinal axis and the back portion extends along a second longitudinal axis, which forms an angle of more than 90° with the first longitudinal axis. The corner half arrow of the '710 publication provides additional material at the side wear portion, adjacent to the back portion, by making the back portion extend obliquely rearwards.

As noted, however, adding material to portions of the GET, as suggested by the '710 publication, can increase stresses acting on hardware used to secure the GET to a work implement.

The corner segment of the present disclosure may solve one or more of the problems set forth above and/or other problems in the art. The scope of the current disclosure, however, is defined by the attached claims, and not by the ability to solve any specific problem.

### SUMMARY

In one aspect of the present disclosure, a corner segment configured to be mounted to a work implement using a plurality of bolts may include a head portion, a base portion, integrally formed with the head portion, and having at least one base bolt hole extending from a lower surface of the base portion to an upper surface of the base portion, the at least one base bolt hole being configured to receive a bolt to secure the corner segment to the work implement, and a side portion, integrally formed with the head portion and the base portion, and having at least one side bolt hole extending from an outer surface of the side portion to an inner surface of the side portion, the at least one side bolt hole being configured to receive a bolt to secure the corner segment to the work implement.

In another aspect of the present disclosure, a corner segment configured to be mounted to a work implement using a plurality of bolts may include a head portion having an upper surface, a lower surface, a front surface, a back surface, and an inner surface, and a base portion, integrally formed with and adjacent to the head portion, and having an upper surface, a lower surface, a back surface, an inner surface, and at least one base bolt hole extending from the upper surface to the lower surface thereof. The corner segment may also include a front side portion, integrally formed with and adjacent to the head portion, and having an upper surface, a lower surface, a front surface, a back surface, an inner surface, and an outer surface, a back side portion, integrally formed with and adjacent to the base portion and the front side portion, and having an upper surface, a lower surface, a back surface, an inner surface, an outer surface, and at least one side bolt hole, extending from the outer surface to the inner surface thereof, and a protrusion, integrally formed with and adjacent to the front side portion and the back side portion, and having a lower surface, an upper surface, and an inner surface.

In still another aspect of the present disclosure, a corner segment configured to be mounted to a work implement using a plurality of bolts may include a head portion having an upper surface, a lower surface, a front surface, a back surface, an inner surface, and a base portion, integrally formed with and adjacent to the head portion, and having a an upper surface, a lower surface, a back surface, an inner surface, and at least one base bolt hole extending from the upper surface to the lower surface thereof. The corner segment may also include a side portion, integrally formed with and adjacent to the head portion and the base portion, the side portion including a front side portion, extending from and adjacent to the head portion, and having an upper surface, a lower surface, a front surface, an inner surface, and an outer surface, and a back side portion, extending from and adjacent to the base portion and the front side portion, and having an upper surface, a lower surface, a back surface, an inner surface, an outer surface, and at least one side bolt hole, extending from the outer surface to the inner surface thereof. A ratio of a maximum width of the front side portion to a minimum width of the front side portion is in a range of 2:1 to 1:1, a ratio of a maximum width of the back side portion to a minimum width of the back side portion is in a range of 2:1 to 1:1, and a ratio of a maximum depth of the front side portion to a depth of the inner surface of the head portion is in a range of 2:1 to 1:1.

### BRIEF DESCRIPTION OF THE DRAWINGS

FIG. 1 shows a schematic view of a bucket, as an example of a work implement, having corner segments as GETs, in accordance with the present disclosure.

FIG. 2, FIG. 3, and FIG. 4 show different schematic isometric views of the corner segment shown in FIG. 1.

FIG. 5 shows a schematic side view of the corner segment shown in FIGS. 1 to 4.

FIG. 6 shows a schematic front view of the corner segment shown in FIGS. 1 to 5.

FIG. 7 shows a schematic top view of the corner segment shown in FIGS. 1 to 6.

FIG. 8 shows a schematic side view of the corner segment shown in FIGS. 1 to 7.

FIG. 9 shows a schematic top view of the corner segment mounted to the work implement.

FIG. 10 shows a schematic front view of the corner segment mounted to the work implement.

FIG. 11 shows a schematic isometric view of the corner segment mounted to the work implement.

FIGS. 12 and 13 show schematic isometric views of a corner segment including an extension, in accordance with the present disclosure.

FIG. 14 shows a schematic isometric view of the corner segment shown in FIGS. 12 and 13, mounted to the work implement.

### DETAILED DESCRIPTION

Both the foregoing general description and the following detailed description are exemplary and explanatory only and are not restrictive of the features, as claimed. As used herein, the terms “comprises,” “comprising,” “having,” including,” or other variations thereof, are intended to cover a non-exclusive inclusion, such that a process, method, article, or apparatus that comprises a list of elements does not include only those elements, but may include other elements not expressly listed or inherent to such a process, method, article, or apparatus. Moreover, in this disclosure, relative terms, such as, for example, “about,” “generally, “substantially,” and “approximately” are used to indicate a possible variation of +10% in the stated value, unless otherwise stated.

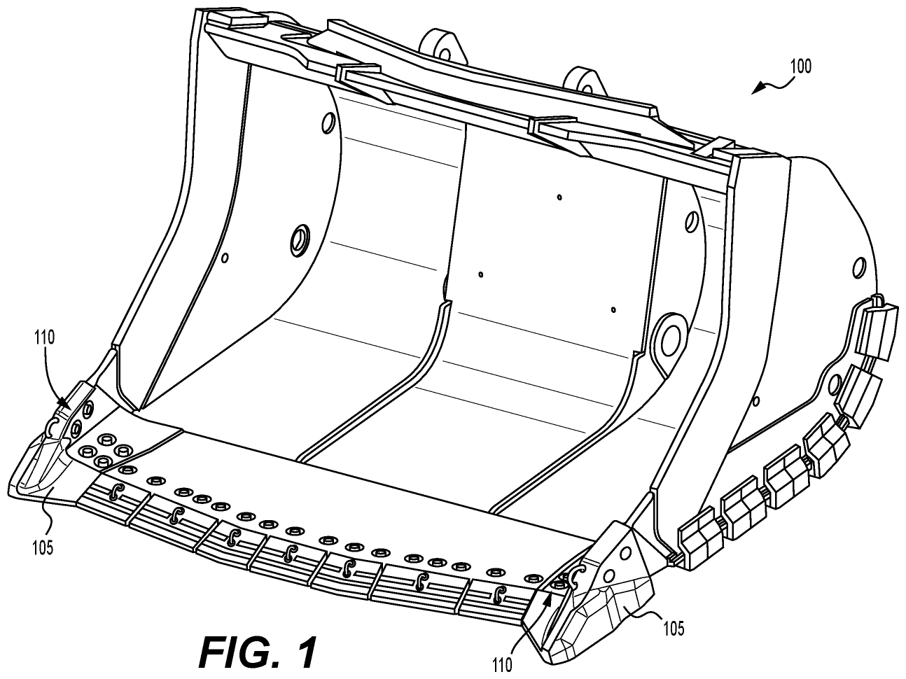

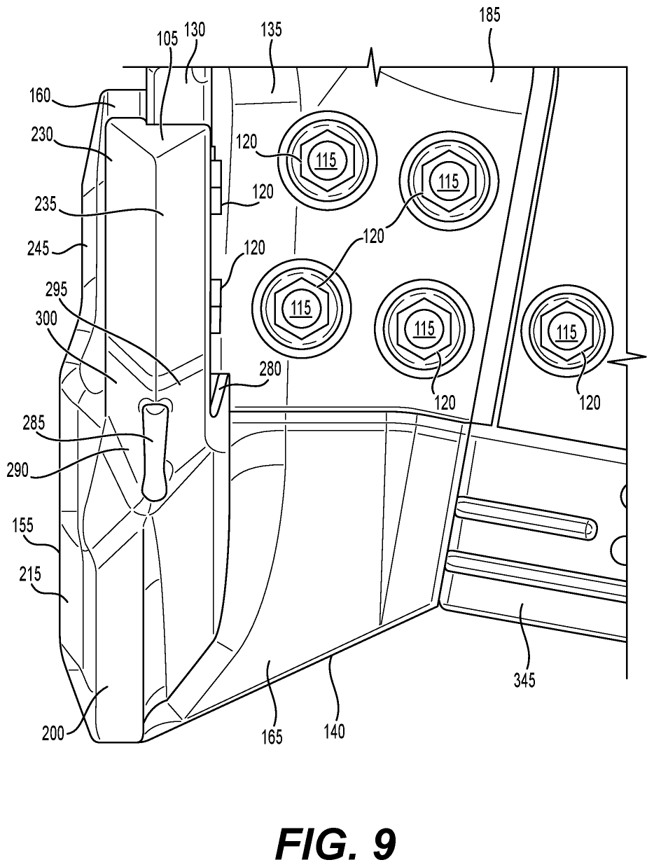

FIG. 1 shows a schematic view of a bucket, as an example of a work implement 100, having two corner segments 105 as ground engaging tools (GETs) mounted to corners of the bucket 100. Each corner segment 105 is mounted to the bucket 100 using a plurality of bolt assemblies 110, including bolts 115 and nuts 120 (shown in FIGS. 9-11), with the bolts 115 extending through a side portion 125 of each corner segment 105 and through sides 130 (shown in FIGS. 9-11) of the bucket 100, and at least one bolt 115 extending through a bottom or a base portion 135 of each corner segment 105 and through a bottom (not shown) of the bucket 100, and each bolt 115 being secured with a nut 120, as shown in FIGS. 9-11. In the embodiment shown in FIG. 1, two bolts 115 extend through the side portion 125 of each corner segment 105, and four bolts 115 extend through the base portion 135 of each corner segment 105, being secured using nuts 120, and thereby securing the corner segments 105 to the bucket 100.

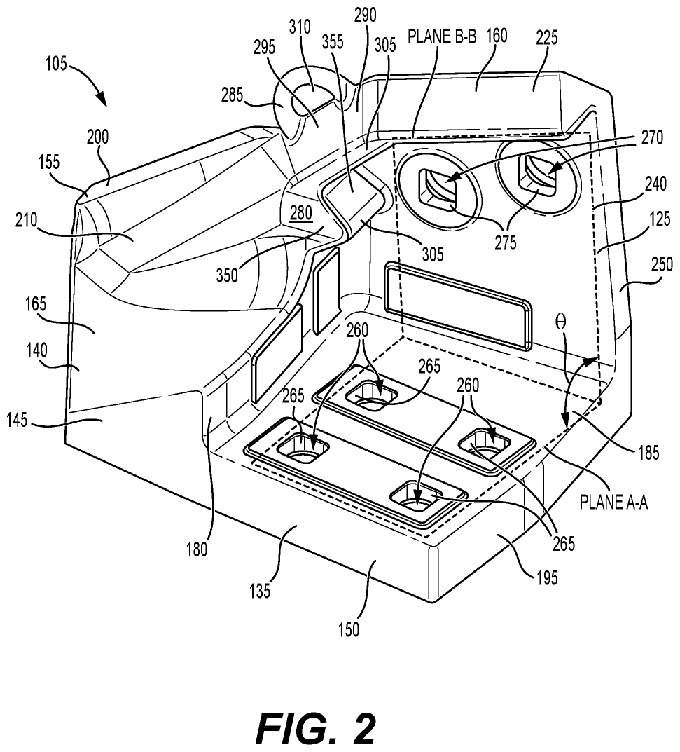

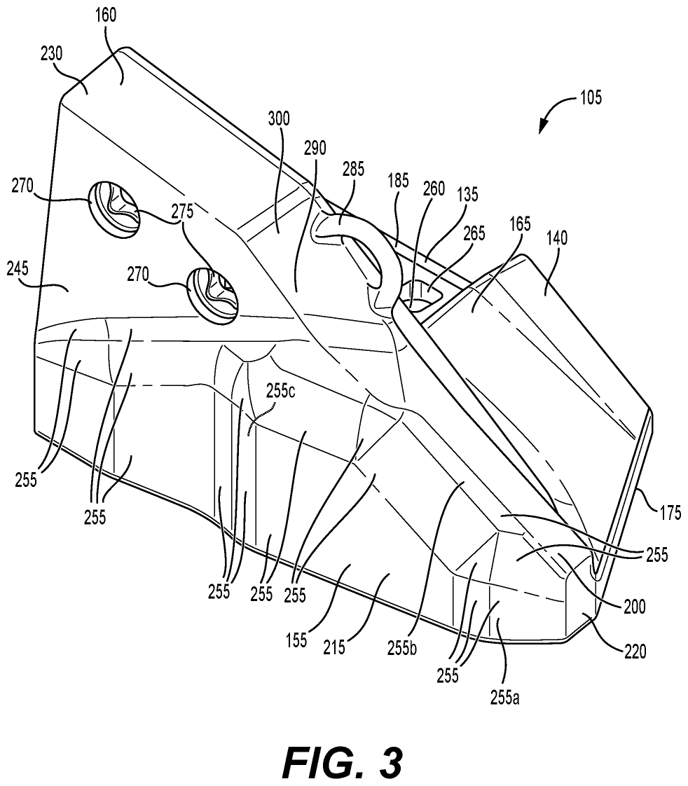

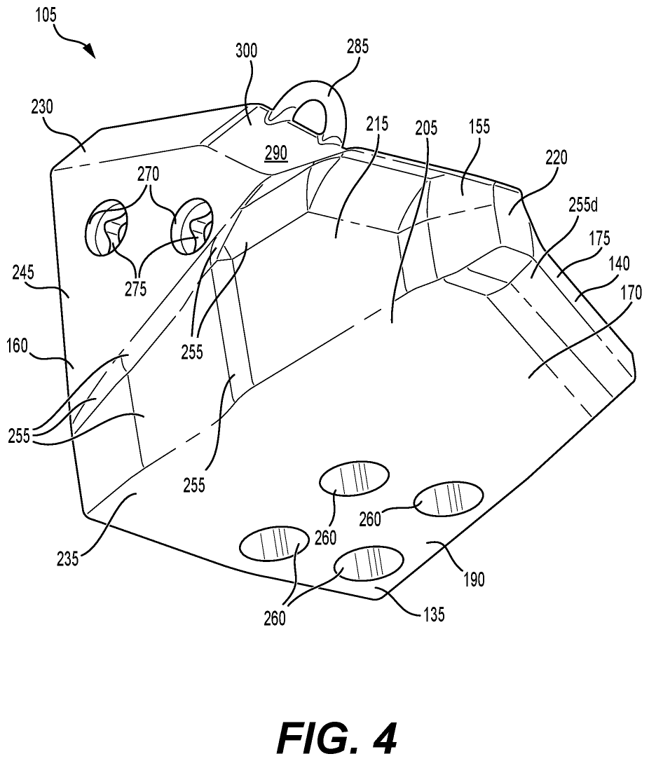

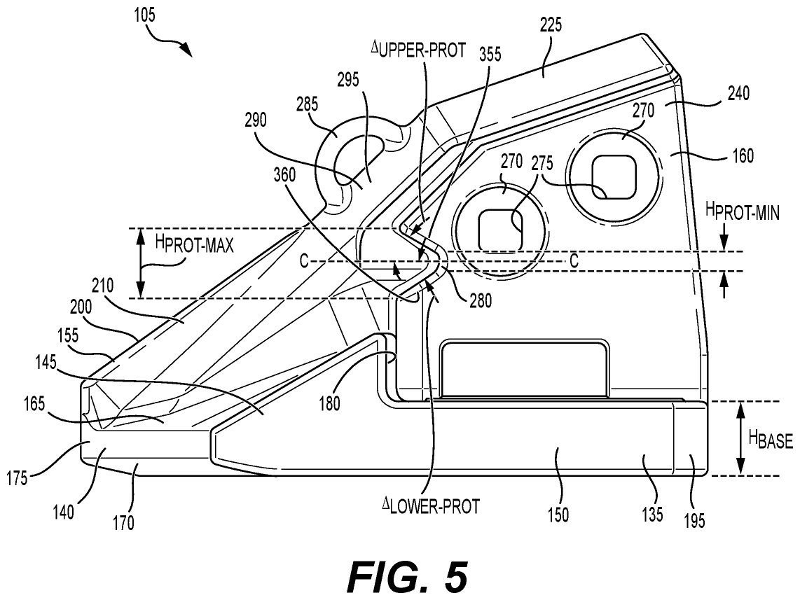

Referring to FIGS. 2-5, in addition to the side portion 125 and the base portion 135, the corner segment 105 includes a front or head portion 140. An inner surface 145 of the head portion 140 and an inner surface 150 of the base portion 135 resemble one half of an arrow, that is, a half arrow, as best shown in FIGS. 2 and 5, and thus, the corner segment 105 described herein may be referred to in some contexts as a bolt-on half arrow (BOHA) corner segment 105.

FIG. 2 shows a schematic rear isometric view of the corner segment 105 shown in FIG. 1. In particular, FIG. 2 shows the head portion 140, the base portion 135, and the side portion 125 of the corner segment 105, all of which are integrally formed as a singular piece. The side portion 125 has a front side portion 155 and a back side portion 160. The head portion 140 is adjacent to the base portion 135 and to the front side portion 155, the base portion 135 is adjacent to the head portion 140 and to the back side portion 160, and the front side portion 155 is adjacent to the head portion 140 and to the back side portion 160. In addition to the inner surface 145, the head portion 140 has an upper surface 165, a lower surface 170 (shown in FIGS. 4 and 5), a front surface 175 (shown in FIGS. 3-6 and 10), and a back surface 180. In addition to the inner surface 150, the base portion 135 has an upper surface 185, a lower surface 190 (shown in FIG. 4), and a back surface 195. The front side portion 155 has an upper surface 200, a lower surface 205 (shown in FIG. 4), an inner surface 210, an outer surface 215 (shown in FIGS. 3, 4, and 8), and a front surface 220 (shown in FIGS. 3, 4, 6, and 10). The back side portion 160 has upper surfaces, including an upper inner surface 225 and an upper outer surface 230 (shown in FIGS. 3, 4, and 6-10), a lower surface 235 (shown in FIG. 4), an inner surface 240, an outer surface 245 (shown in FIGS. 3, 4, and 8), and a back surface 250. FIG. 2 shows the upper surface 165, the inner surface 145, and the back surface 180 of the head portion 140, the upper surface 185, the inner surface 150, and the back surface 195 of the base portion 135, the upper surface 200 and the inner surface 210 of the front side portion 155, and the upper inner surface 225, the inner surface 240, and the back surface 250 of the back side portion 160.

The various surfaces of the corner segment 105 described herein meet adjacent surfaces, at intermediate surfaces or interfaces, as shown in the accompanying figures and discussed in more detail below. At least some of the surfaces, including the intermediate surfaces, are chamfered surfaces 255, such that relative widths, heights, and/or depths of the respective portions of the corner segment 105 change along the chamfered surfaces 255, as discussed in more detail below. In addition, the corner segment 105 may be formed of steel, for example. The material that forms the corner segment 105 is not, however, limited to steel, and other materials may be used.

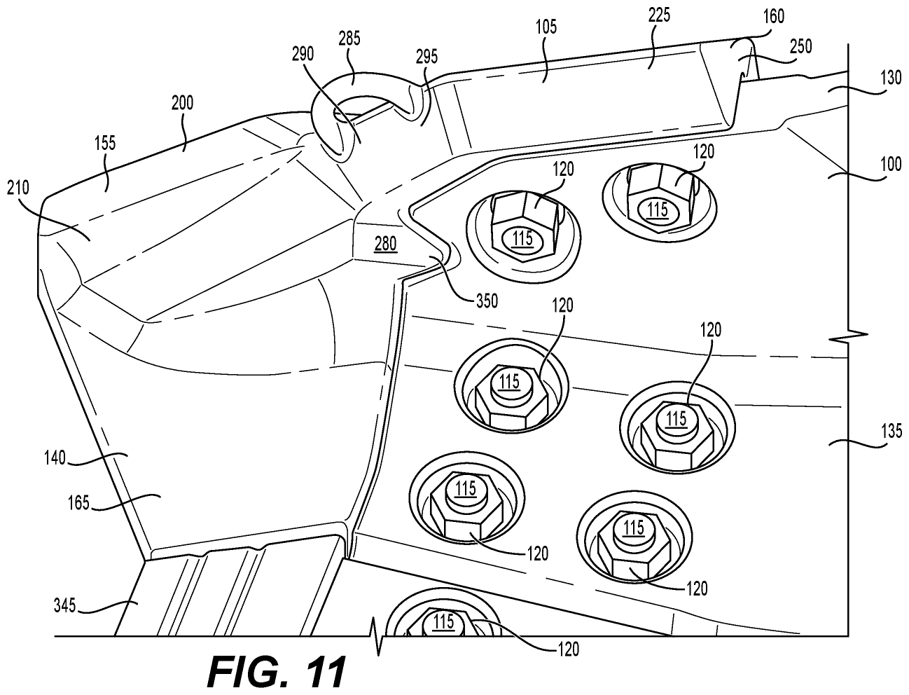

FIG. 2 also shows bolt holes 260 in the base portion 135, the bolt holes 260 extending through the base portion 135 from the upper surface 185 to the lower surface 190, and being configured to receive bolts 115 to secure the corner segment 105 to the work implement 100. The base portion 135 shown in the accompanying figures includes four bolt holes 260, although the base portion 135 may have less than or more than four bolt holes 260. The bolt holes 260 in the base portion 135 may include counter bores 265 near the upper surface 185 of the base portion 135. A shape of the counter bores 265 may be generally square with rounded corners, although other shapes may be used. The back side portion 160 also has at least one bolt hole 270, extending through the back side portion 160 from the inner surface 240 to the outer surface 245, and being configured to receive a bolt 115 to secure the corner segment 105 to the work implement 100. The back side portion 160 shown in the accompanying figures includes two bolt holes 270, however, the back side portion 160 may have a single bolt hole 270 or more than two bolt holes 270, and the bolt holes 270 may be located on the front side portion 155 or on both the front side portion 155 and the back side portion 160. The bolt holes 270 may include counter bores 275 near the inner surface 240 of the back side portion 160. A shape of the counter bores 275 may be generally square with rounded corners, although other shapes may be used. A plane A-A of the bolt holes 260 of the base portion 135 and a plane B-B of the bolt holes 270 of the back side portion 160 are at an angle θ relative to each other. In one example, θ is about 90°. As noted above with respect to FIG. 1, and as discussed below with respect to FIG. 11, the corner segment 105 is secured to the work implement 100 using bolts 115 inserted into each bolt hole 260 and 270 and a nut 120 threaded onto each bolt 115 within the counter bores 265 in the base portion 135 and the counter bores 275 in the back side portion 160, as will be understood by a person of skill in the art. That is, the bolts 115 may be inserted from the lower surface 190 toward the upper surface 185 of the base portion 135, and from the outer surface 245 toward the inner surface 240 of the back side portion 160, and secured using a nut 120.

The bolt holes 260 and 270 being provided on both the back side portion 160 and the base portion 135 of the corner segment 105 provide for a GET that is relatively easier and safer to replace in the field (for example, underground at a mining site), as compared to a welded GET. Further, the corner segment 105 having bolt holes 260 and 270 in two surfaces, that is, in two different planes, reduces the chance of failure of the bolts 115 (i.e., bolt shear) and possible disengagement of the corner segment 105 from the work implement 100.

FIG. 2 also shows a protrusion 280, extending from the front side portion 155, along the inner surface 240 of the back side portion 160, and which includes an inner surface 350, an upper surface 355, a lower surface 360 (shown in FIG. 5), and a protrusion point or end 365. The upper surface 355 and the lower surface 360 converge towards each other towards the back end, or end 365. In addition, FIG. 2 shows an eye 285 provided on an intermediate portion 290 of the side portion 125, in between the front side portion 155 and the back side portion 160. The eye 285 may comprise a semi-circle of the same material that forms the corner segment 105, forming an opening 310 through which a hook, a bar, or other implement may be inserted for lifting and moving the corner segment 105. The intermediate portion 290 may include an upper inner inclined surface 295, an upper outer inclined surface 300 (shown in FIGS. 3, 4, and 6-10), and a lower surface 305.

FIG. 3 shows another schematic isometric view of the corner segment 105 shown in FIG. 1. In particular, FIG. 3 shows the upper surface 165 and the front surface 175 of the head portion 140, and the upper surface 185 of the base portion 135. FIG. 3 also shows the upper surface 200, the outer surface 215, and the front surface 220 of the front side portion 155, and the outer surface 245 and the upper outer surface 230 of the back side portion 160. In addition, FIG. 3 shows the two bolt holes 270 in the back side portion 160, and the counter bores 275 of these side bolt holes 270. FIG. 3 also shows the upper outer inclined surface 300 of the intermediate portion 290 and the eye 285.

In the embodiment shown in FIG. 3, and as noted above, intermediate surfaces, or interfaces, between surfaces of the back side portion 160 and the front side portion 155 are chamfered surfaces 255, such that a relative width of the side portion 125 changes or reduces along the chamfered surfaces 255. Some of the chamfered surfaces 255 may be flat while others may be curved, having a radius of curvature in a range of 100 mm to 200 mm. As one specific example, a chamfered surface 255a between the front surface 220 of the front side portion 155 and the outer surface 215 of the front side portion 155 may be curved, with a radius of curvature of about 50 mm to 150 mm. In particular, for example, the radius of curvature of surface 255a may be about 100 mm. The chamfered surface 255a may be convex. As another specific example, a chamfered surface 255b between the upper surface 200 of the front side portion 155 and the outer surface 215 of the front side portion 155 may be flat. As still another specific example, a chamfered surface 255c between the outer surface 215 of the front side portion 155 and the outer surface 245 of the back side portion 160 may be curved, with a radius of curvature of about 30 mm to about 200 mm. In particular, for example, the radius of curvature of surface 255c may be about 90 mm. The chamfered surface 255c may be convex. As still another specific example, a chamfered surface 255d (shown in FIG. 4) between the lower surface 170 of the head portion 140 and the front surface 175 of the head portion 140 may be flat. The chamfered surfaces 255 provide for a corner segment 105 having a relatively reduced mass, and help to prevent the corner segment 105 from getting caught, for example on sidewalls or wall undercuts of a tunnel at a worksite, when, for example, the work implement 100 is backed up or dragged in a rearward direction.

FIG. 4 shows still another schematic isometric view of the corner segment 105 shown in FIGS. 1-3. In particular, FIG. 4 shows the lower surface 170 and the front surface 175 of the head portion 140, the lower surface 190 of the base portion 135, the front surface 220, the outer surface 215, and the lower surface 205 of the front side portion 155, and the upper outer surface 230, the outer surface 245, and the lower surface 235 of the back side portion 160. FIG. 4 also shows the chamfered surfaces 255 of the back side portion 160 and the chamfered surfaces 255 of the front side portion 155. In addition, FIG. 4 shows the chamfered surface 255d of the head portion 140, where a relative height of the head portion 140 decreases towards the front surface 175 thereof. The chamfered surface 255d on the head portion 140 improves the ability of the corner segment 105 to penetrate a pile of debris, by reducing a vertical surface area, which is, reducing an area of the front surface 175 of the head portion 140.

FIG. 4 also shows the two bolt holes 270 in the front side portion 155, and a portion of the counter bores 275 of these side bolt holes 270. In addition, FIG. 4 shows the four bolt holes 260 in the base portion 135. Further, FIG. 4 shows another view of the eye 285 and of the upper outer inclined surface 300 of the intermediate portion 290.

FIG. 5 shows a schematic side view of the corner segment 105 shown in FIGS. 1 to 4. In particular, FIG. 5 shows the upper surface 165, the lower surface 170, the front surface 175, the inner surface 145, and the back surface 180 of the head portion 140, the inner surface 150 and the back surface 195 of the base portion 135, the inner surface 210 and the upper surface 200 of the front side portion 155, and the upper inner surface 225 and the inner surface 240 of the back side portion 160. In addition, FIG. 5 shows the two bolt holes 270 in the back side portion 160, including the counter bores 275 for same. FIG. 5 also shows the protrusion 280 and the eye 285, as well as the upper inner inclined surface 295 of the intermediate portion 290.

FIG. 5 also shows a height HBASE of the base portion 135 as well as a maximum height H_{PROT-MAX} of the protrusion 280, at a front end, towards the front side portion 155 (or towards a front of the front side portion 155), and a minimum height H_{PROT-MIN}, at a back end, towards the back side portion 160 (or towards the back of the back side portion 160), as well as the upper surface 355 and the lower surface 360 of the protrusion 280. The protrusion 280 also has an inner surface 350 that extends between the upper surface 355 and the lower surface 360 thereof. An angle Δ_{UPPER-PROT} between the upper surface 355 of the protrusion 280 and a horizontal axis C-C may be in a range of 10° to 60°, and, more specifically, for example, may be 30°. And an angle Δ_{LOWER-PROT} between the lower surface 360 of the protrusion 280 and the horizontal axis C-C may be in in a range of 15° to 65°, and, more specifically, for example, may be 35°. In some embodiments, Δ_{UPPER-PROT} and Δ_{LOWER-PROT} may be the same value, and in other embodiments, Δ_{UPPER-PROT} and Δ_{LOWER-PROT} may be different values. The upper surface 355 and the lower surface 360 of the protrusion 280 meet at a point or an end 365 of the protrusion 280. The protrusion 280 may be beak-shaped. The protrusion 280 provides additional surfaces in varying planes that engage with surfaces of the work implement 100. In other words, the protrusion 280 provides for increased contact area between the corner segment 105 and the work implement 100, particularly during downloading (that is, loading of debris downward from the work implement 100) and decreases stress acting on hardware, namely, the bolts 115. Further, the protrusion 280 provides additional support of the corner segment 105 in case one or more of the bolts 115 fail (that is, in case some, but not all, of the bolts 115 fail).

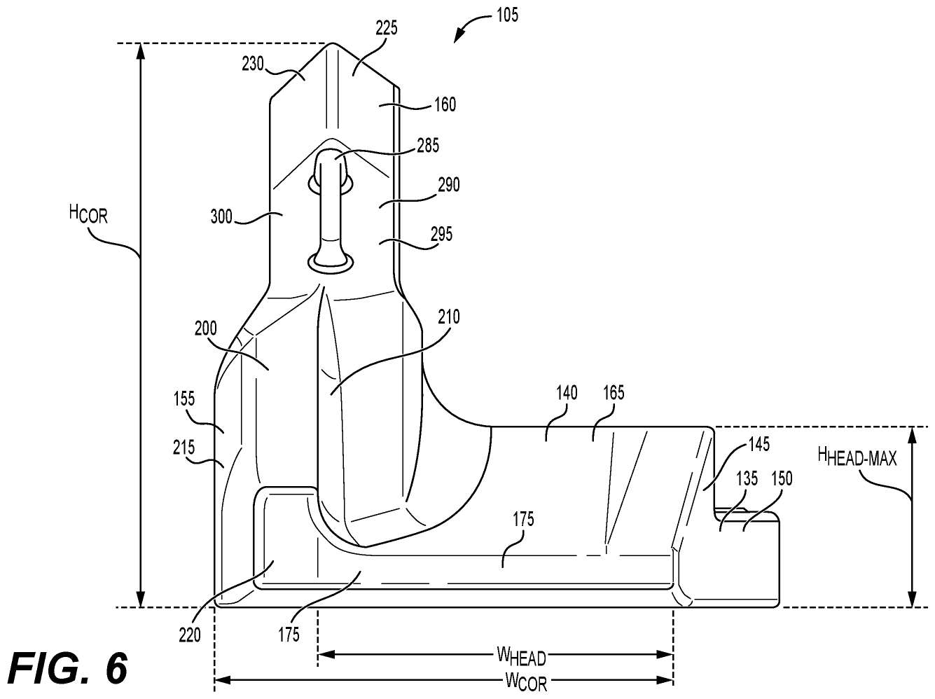

FIG. 6 shows a schematic front view of the corner segment 105 shown in FIGS. 1 to 5. In particular, FIG. 6 shows the front surface 175, the upper surface 165, and the inner surface 145 of the head portion 140, the inner surface 150 of the base portion 135, the front surface 220, the upper surface 200, the inner surface 210, and the outer surface 215 of the front side portion 155, and the upper outer surface 230 and the upper inner surface 225 of the back side portion 160. FIG. 6 also shows the intermediate portion 290, including the upper outer inclined surface 300 and the upper inner inclined surface 295 thereof, as well as the eye 285.

FIG. 6 also shows an overall width W_{COR} of the corner segment 105, which may be in a range of 250 mm to 500 mm, and an overall height H_{COR} of the corner segment 105, which may be in a range of 200 mm to 600 mm. FIG. 6 also shows a width W_{HEAD} of the head portion 140, which may be in a range of 100 mm to 400 mm, a minimum height H_{HEAD-MIN} of the head portion 140, and a maximum height H_{HEAD-MAX} of the head portion 140, which may be in a range of 75 mm to 200 mm.

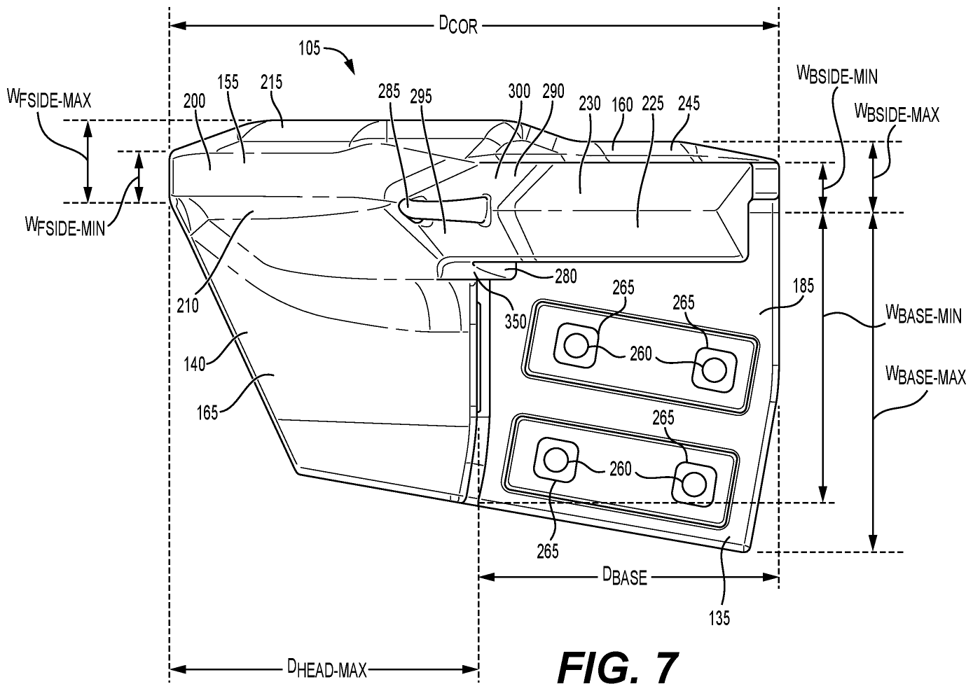

FIG. 7 shows a schematic top view of the corner segment 105 shown in FIGS. 1 to 6. In particular, FIG. 7 shows the upper surface 165 of the head portion 140, the upper surface 185 of the base portion 135, the upper surface 200, the inner surface 210, and the outer surface 215 of the front side portion 155, and the upper outer surface 230, the upper inner surface 225, and the outer surface 245 of the back side portion 160. FIG. 7 also shows the upper outer inclined surface 300 and the upper inner inclined surface 295 of the intermediate portion 290, as well as the eye 285.

FIG. 7 also shows an overall depth D_{COR} of the corner segment 105, which may be in a range of 350 mm to 750 mm, a minimum head depth D_{HEAD-MIN} of the head portion 140, and a maximum head depth D_{HEAD-MAX} of the head portion 140, which may be in a range of 200 mm to 400 mm. The base portion 135 may have a minimum width W_{BASE-MIN} in a range of 200 mm to 350 mm, and a maximum width W_{BASE-MAX} in a range of 250 mm to 400 mm. In addition, FIG. 7 shows a depth DBASE of the base portion 135, which may be in a range of 150 mm to 400 mm. The front side portion 155 may have a minimum width W_{FSIDE-MIN}, which may be in a range of 20 mm to 75 mm, and a maximum width W_{FSIDE-MAX}, which may be in a range of 50 mm to 150 mm. A ratio of W_{FSIDE-MIN} to W_{FSIDE-MAX} may be in a range of 2:1 to 1:1, and, more specifically, for example, the ratio of W_{FSIDE-MIN} to W_{FSIDE-MAX} may be 1.875:1. The back side portion 160 may have a minimum width W_{BSIDE-MIN} in a range of 30 mm to 70 mm, and a maximum width W_{BSIDE-MAX} in a range of 40 mm to 120 mm. A ratio of W_{BSIDE-MIN} to W_{BSIDE-MAX} may be in a range of 2:1 to 1:1, and, more specifically for example, the ratio of W_{BSIDE-MIN} to W_{BSIDE-MAX} 1.5:1. The maximum width of the back side portion 160 W_{BSIDE-MAX} may be less than the maximum width of the front side portion 155 W_{FSIDE-MAX}. In other words, the width of the side portion 125 of the corner segment 105 may decrease from the front end thereof towards the back end thereof.

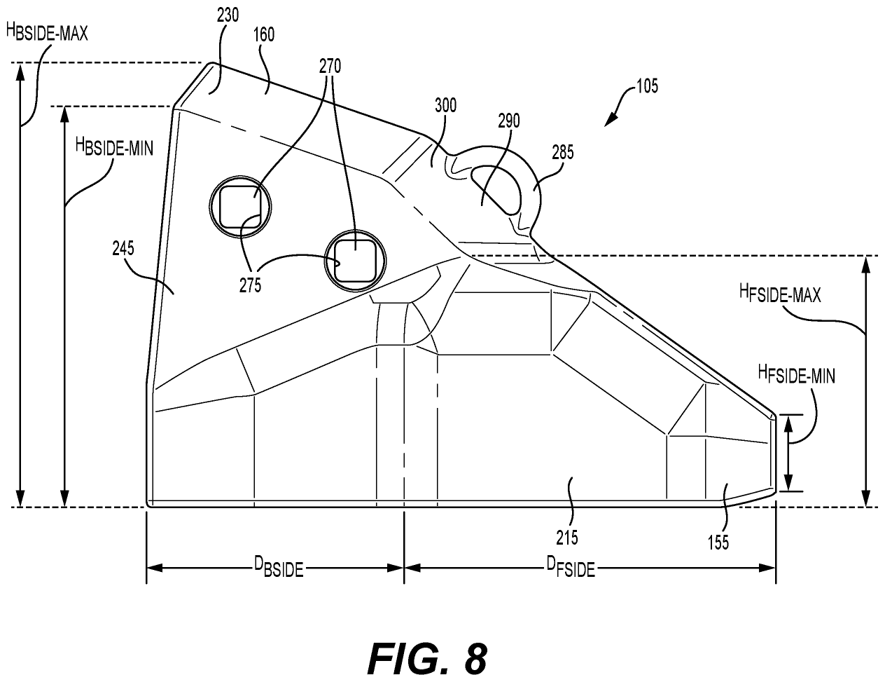

FIG. 8 shows a schematic side view of the corner segment 105 shown in FIGS. 1 to 7. In particular, FIG. 8 shows the outer surface 215 of the front side portion 155, and the outer surface 245 and the upper outer surface 230 of the back side portion 160. FIG. 8 also shows the upper outer inclined surface 300 of the intermediate portion 290, and the eye 285. Further, FIG. 8 shows the two bolt holes 270 in the back side portion 160, including the generally square-shaped counter bores 275.

FIG. 8 also shows minimum height H_{FSIDE-MIN} of the front side portion 155, which may be in a range of 30 mm to 150 mm, a maximum height H_{FSIDE-MAX} of the front side portion 155, which may be in a range of 150 mm to 400 mm, and a depth D_{FSIDE} of the front side portion 155, which may be in a range of 250 mm to 500 mm. A ratio of D_{FSIDE} to D_{HEAD-MAX} may be in a range of 2:1 to 1:1 and, more specifically, the ratio of D_{FSIDE} to D_{HEAD-MAX} may be 1:1.

Further, FIG. 8 shows a minimum height H_{BSIDE-MIN} of the back side portion 160, which may be in a range of 200 mm to 600 mm, a maximum height H_{BSIDE-MAX} of the back side portion 160, which may be in a range of 250 mm to 650 mm, and a depth D_{BSIDE} of the back side portion 160, which may be in a range of 100 mm to 400 mm.

FIG. 9 shows a schematic top view of the corner segment 105 mounted to the work implement 100, and adjacent to a front segment 345. In particular, FIG. 9 shows the upper surface 165 of the head portion 140, the upper surface 185 of the base portion 135, the upper surface 200, the inner surface 210, and the outer surface 215 of the front side portion 155, and the upper outer surface 230, the upper inner surface 225, and the outer surface 245 of the back side portion 160. In addition, FIG. 9 shows the nuts 120 securing bolts 115 inserted through the bolt holes 260 in the base portion 135. FIG. 9 also shows the upper outer inclined surface and the upper inner inclined surface of the intermediate portion 290, as well as the eye 285. Further, FIG. 9 shows the protrusion 280.

FIG. 9 also shows an overall wing shape of the corner segment 105, achieved by the additional wear material (i.e., material that forms the corner segment 105) provided towards the front and outer corner of the corner segment 105. The additional wear material prolongs the work life of the corner segment 105, and, therefore, reducing the frequency at which the corner segment 105 needs to be replaced and, in turn, reducing the downtime of the machine on which the work implement 100 with the corner segment 105 is installed.

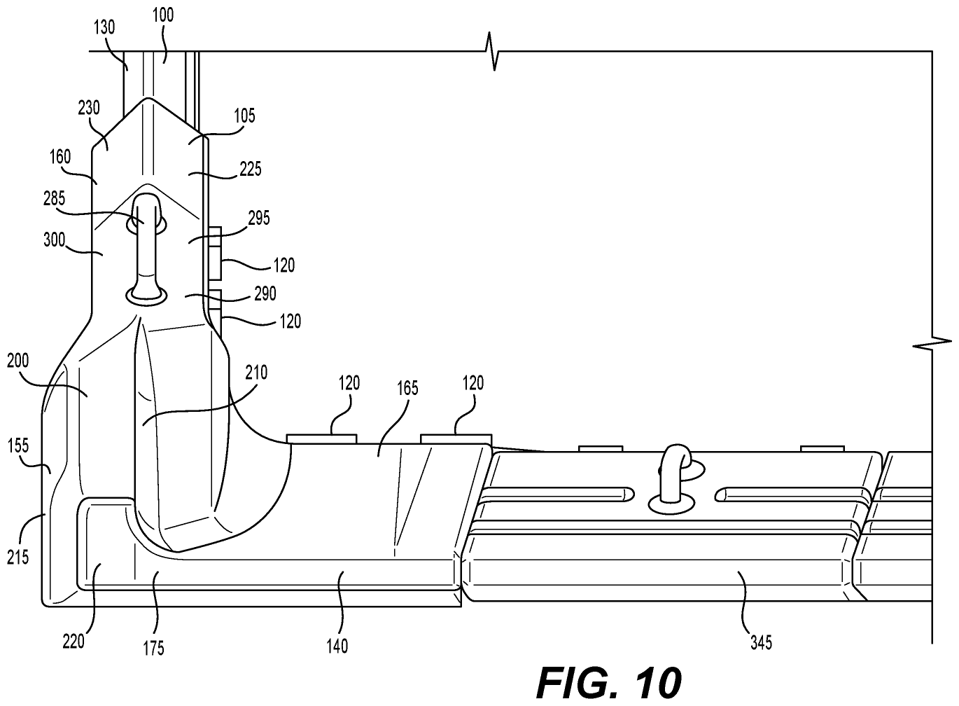

FIG. 10 shows a schematic front view of the corner segment 105 mounted to the work implement 100, and adjacent to the front segment 345. In particular, FIG. 10 shows the front surface 175 and the upper surface 165 of the head portion 140, the front surface, the upper surface 200, the inner surface 210, and the outer surface 215 of the front side portion 155, and the upper outer surface 230 and the upper inner surface 225 of the back side portion 160. FIG. 10 also shows the upper outer inclined surface 300 and the upper inner inclined surface 295 of the intermediate portion 290, as well as the eye 285.

FIG. 11 shows a schematic isometric view of the corner segment 105 mounted to the work implement 100, and adjacent to the front segment 345. In particular, FIG. 11 shows the upper surface 165 of the head portion 140, the upper surface 200 and the inner surface 210 of the front side portion 155, and the back surface 250 and the upper inner surface 225 of the back side portion 160. FIG. 11 also shows the two bolt holes 270 in the back side portion 160 and the four bolt holes 260 in the base portion 135, with nuts 120 securing bolts 115 inserted through the bolt holes 260 and 270. FIG. 11 also shows the upper inner inclined surface 295 of the intermediate portion 290, as well as the eye 285. In addition, FIG. 11 shows the inner surface 350 of the protrusion 280. In addition, FIG. 11 shows the corner segment 105 secured to the work implement 100 using bolts 115 inserted into each bolt hole 260 and 270 and a nut 120 threaded onto each bolt 115.

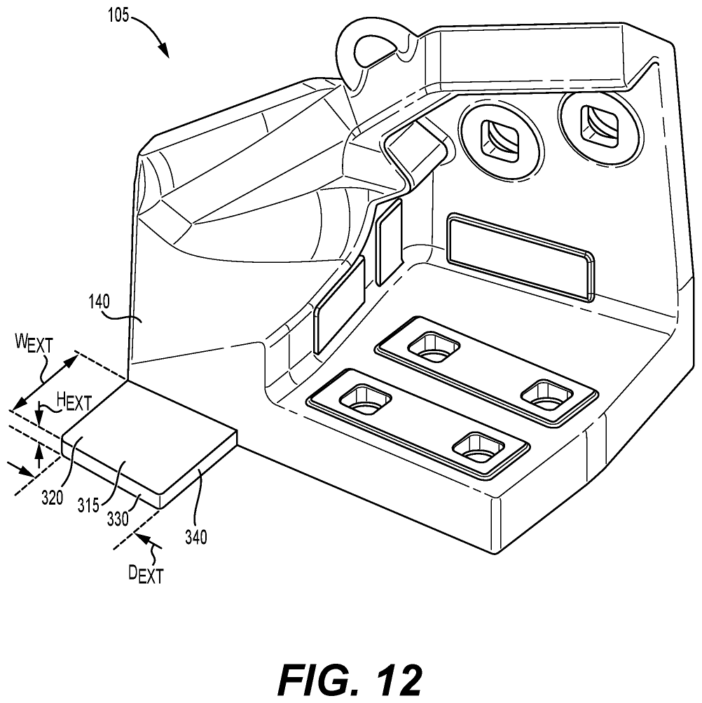

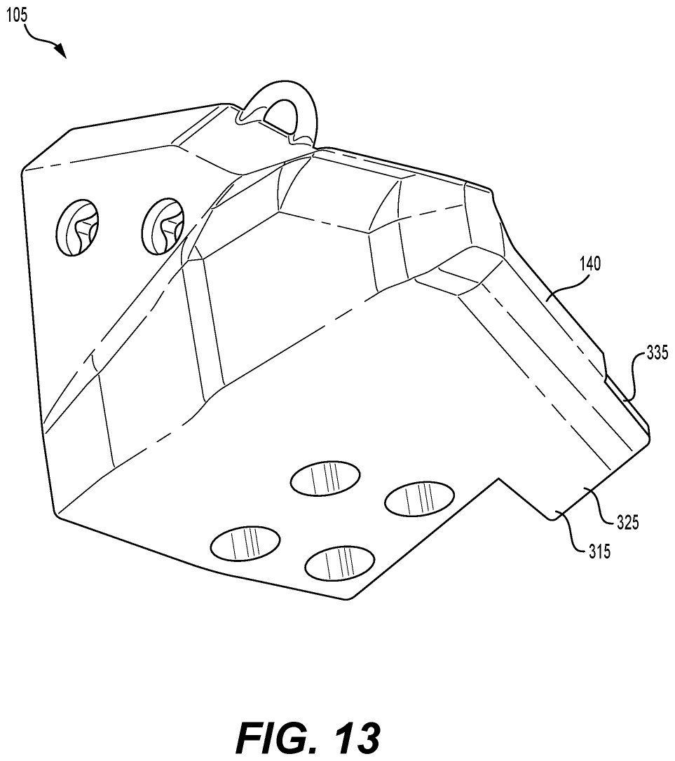

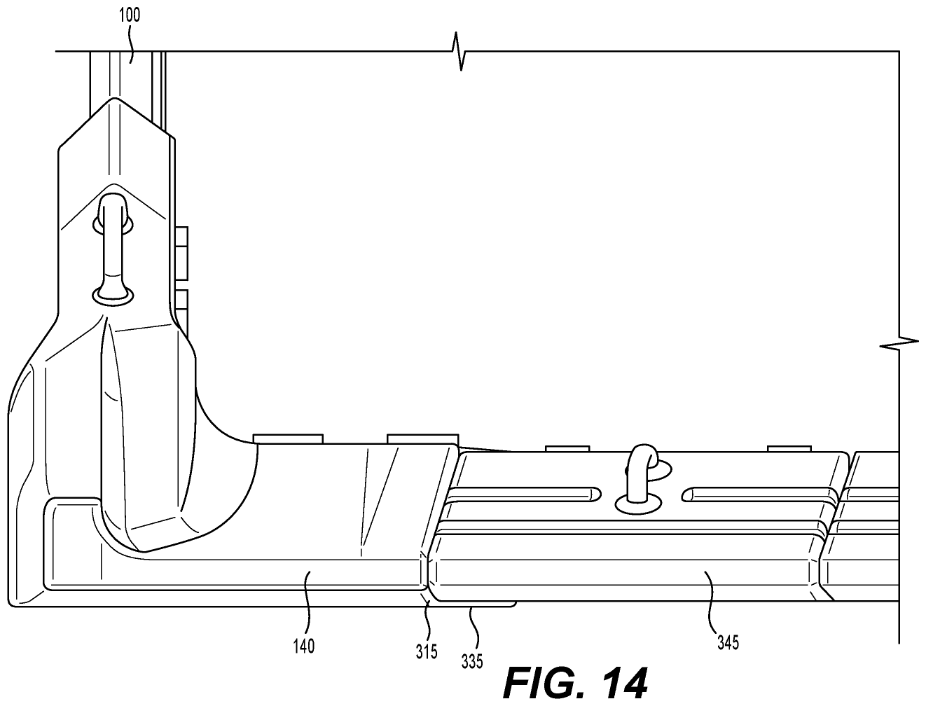

FIGS. 12 and 13 show a corner segment 105, according to one alternative embodiment, with an extension 315 that is integrally formed with and extending from the head portion 140. The extension 315 has an upper surface 320, a lower surface 325, an inner surface 330, a front surface 335, and a back surface 340. FIG. 14 shows the extension 315 positioned to sit underneath a neighboring front segment 345 provided on the work implement 100. As one example, the extension 315 is sized to extend about 6 mm to about 10 mm underneath the neighboring front segment 345. In other words, the extension 315 has a width sufficient to extend at least about 6 mm to about 10 mm underneath the neighboring front segment 345.

The extension 315 may have a width W_{EXT}, a depth D_{EXT}, and a height H_{EXT}. The width W_{EXT} of the extension 315 as compared to the overall width W_{COR} of the corner segment 105 (that is, a ratio of the width W_{EXT} to the width W_{COR}) may be determined so as to reduce and/or minimize the possibility of the corner segment 105 gouging a floor of a worksite.

### INDUSTRIAL APPLICABILITY

The corner segment 105 of the present disclosure provides for a replaceable part for a work implement 100 of a machine that is relatively easier and safer to replace, particularly in the field, without need to remove the machine rom a worksite. The corner segment 105 also has a reduced risk of failure and disengagement from the work implement 100, by virtue of the bolt holes 260 and 270 being provided on multiple surfaces, with those surfaces being in two different planes, planes A-A and B-B. Further, the relative dimensions of certain portions of the corner segment 105 reduce and/or minimize the possibility of gouging a floor of a worksite (that is, gouging the ground) and thus creating uneven work surfaces, and reduce the possibility of fracture of one or more portions of the corner segment 105. Specifically, for example, a ratio of the width W_{EXT} of an extension 315 of the corner segment 105 to the overall width W_{COR} of the corner segment 105 may be determined to reduce and/or minimize the possibility of ground of the floor underneath the corner segment 105.

The corner segment 105 of the present disclosure also has chamfered surfaces 255, providing for a corner segment 105 having a relatively reduced mass and that is less likely to get caught on surfaces of a worksite, such as sidewalls or wall undercuts of a tunnel at a worksite, such as a mining site. The chamfered surfaces 255 near and on the front of the corner segment 105 also provide for sufficient penetration of a pile of debris, by virtue of a reduced vertical surface area on a front end of the corner segment 105. Finally, the relatively large depth and width of the corner segment 105 towards the outer front end prolong the work life of the corner segment 105, and thus reduce the frequency at which the corner segment 105 needs to be replace and, in turn, reduce the downtime of the machine on which the work implement 100 with the corner segment 105 is installed.

It will be apparent to those skilled in the art that various modifications and variations can be made to the disclosed corner segment without departing from the scope of the disclosure. Other embodiments of the corner segment will be apparent to those skilled in the art from consideration of the specification and the accompanying figures. It is intended that the specification, and, in particular, the examples provided herein be considered as exemplary only, with a true scope of the disclosure being indicated by the following claims and their equivalents.

We claim:

1. A corner segment configured to be mounted to a work implement using a plurality of bolts, the corner segment comprising:
a head portion;
a base portion, integrally formed with the head portion, and having at least one base bolt hole extending from a lower surface of the base portion to an upper surface of the base portion, the at least one base bolt hole being configured to receive a bolt to secure the corner segment to the work implement; and
a side portion, integrally formed with the head portion and the base portion, and having at least one side bolt hole extending from an outer surface of the side portion to an inner surface of the side portion, the at least one side bolt hole being configured to receive a bolt to secure the corner segment to the work implement.

2. The corner segment according to claim 1, wherein a plane of the at least one base bolt hole and a plane of the at least one side bolt hole are at an angle of about 90° relative to each other.

3. The corner segment according to claim 1, wherein the base portion has four base bolt holes.

4. The corner segment according to claim 1, wherein the side portion has two side bolt holes.

5. The corner segment according to claim 1, further comprising a protrusion, provided on the inner surface of the side portion.

6. The corner segment according to claim 5, wherein the protrusion has a maximum height at a front end, towards a front of the side portion, and a minimum height at a back end, towards a back of the side portion.

7. A corner segment configured to be mounted to a work implement using a plurality of bolts, the corner segment comprising:
a head portion having an upper surface, a lower surface, a front surface, a back surface, and an inner surface;
a base portion, integrally formed with and adjacent to the head portion, and having an upper surface, a lower surface, a back surface, an inner surface, and at least one base bolt hole extending from the upper surface to the lower surface thereof;
a front side portion, integrally formed with and adjacent to the head portion, and having an upper surface, a lower surface, a front surface, a back surface, an inner surface, and an outer surface;
a back side portion, integrally formed with and adjacent to the base portion and the front side portion, and having an upper surface, a lower surface, a back surface, an inner surface, an outer surface, and at least one side bolt hole, extending from the outer surface to the inner surface thereof; and
a protrusion, integrally formed with and adjacent to the front side portion and the back side portion, and having a lower surface, an upper surface, and an inner surface.

8. The corner segment according to claim 7, wherein the protrusion has a front end with a maximum height and a back end with a minimum height.

9. The corner segment according to claim 8, wherein the upper surface and the lower surface of the protrusion both extend from the front end to the back end, and converge towards each other at the back end.

10. The corner segment according to claim 7, wherein an angle of the upper surface of the protrusion, relative to a horizontal axis of the corner segment is in a range of 10° to 60°.

11. The corner segment according to claim 7, wherein an angle of the lower surface of the protrusion, relative to a horizontal axis of the corner segment is in a range of 15° to 65°.

12. The corner segment according to claim 7, wherein a plane of the at least one base bolt hole and a plane of the at least one side bolt hole are at an angle of about 90° relative to each other.

13. A corner segment configured to be mounted to a work implement using a plurality of bolts, the corner segment comprising:
a head portion having an upper surface, a lower surface, a front surface, a back surface, an inner surface;
a base portion, integrally formed with and adjacent to the head portion, and having a an upper surface, a lower surface, a back surface, an inner surface, and at least one base bolt hole extending from the upper surface to the lower surface thereof; and
a side portion, integrally formed with and adjacent to the head portion and the base portion, the side portion including:
a front side portion, extending from and adjacent to the head portion, and having an upper surface, a lower surface, a front surface, an inner surface, and an outer surface; and
a back side portion, extending from and adjacent to the base portion and the front side portion, and having an upper surface, a lower surface, a back surface, an inner surface, an outer surface, and at least one side bolt hole, extending from the outer surface to the inner surface thereof,
wherein a ratio of a maximum width of the front side portion to a minimum width of the front side portion is in a range of 2:1 to 1:1, and a ratio of a maximum width of the back side portion to a minimum width of the back side portion is in a range of 2:1 to 1:1, and
wherein a ratio of a maximum depth of the front side portion to a depth of the inner surface of the head portion is in a range of 2:1 to 1:1.

14. The corner segment according to claim 13, wherein an interface between the front surface of the front side portion and the outer surface of the front side portion is chamfered, and has a radius of curvature of about 50 mm to about 150 mm.

15. The corner segment according to claim 13, wherein an interface between the upper surface of the front side portion and the outer surface of the front side portion is chamfered.

16. The corner segment according to claim 13, wherein an interface between the outer surface of the front side portion and the outer surface of the back side portion is chamfered, and has a radius of curvature of about 30 mm to about 200 mm.

17. The corner segment according to claim 13, wherein an interface between the lower surface of the head portion and the front surface of the head portion is chamfered.

18. The corner segment according to claim 13, wherein a maximum width of the back side portion is less than the maximum width of the front side portion.

19. The corner segment according to claim 13, further comprising an intermediate portion, provided between the front side portion and the back side portion, the intermediate portion having an eye with an opening configured for use for lifting or moving the corner segment.

20. The corner segment according to claim 13, further comprising an extension, integrally formed with and extending from the head portion.
